(19) United States
(12) Patent Application Publication
(10) Pub. No.: US 2004/0251264 A1
(43) Pub. Date: Dec. 16, 2004

(54) Device for applying labels as well as use of a holder for the lables

(76) Inventor: Fritz Brinkmann, Rettenbach (DE)

Correspondence Address: JORDAN AND HAMBURG LLP, 122 EAST 42ND STREET, SUITE 4000, NEW YORK, NY, 10168, US

(21) Appl. No.: 10/475,201

(22) PCT Filed: Sep. 24, 2002
(86) PCT No.: PCT/EP02/10702

(30) Foreign Application Priority Data
Jan. 29, 2002 (DE) 102 03 363.3

(51) Int. Cl. G07F 11/72

(52) U.S. Cl. 221/31

(57) ABSTRACT

The invention relates to a device for applying individual labels from a web of the same, said web taking the form of a strip or sleeve and said labels being applied to objects, preferably bottles. The device comprises a storage container for the labels that are to be applied. The storage container is configured as an interchangeable box, containing the labels in layers of loose accordion-folds. According to the invention, the uppermost layer of the web is drawn off for dispensing the labels and the undermost layer of the web is fed back at least up to the height of the uppermost layer and is freely accessible from the exterior of the box as an end piece.

The invention relates to a device for applying individual labels from a tape of the same in the form of strips or a flexible tube, the labels being applicable on objects, preferably on bottles, with a holder for the labels, which are to be applied, in accordance with the introductory portion of the main claim, as well as to the use of a holder.

Devices for applying labels are known in a plurality of embodiments. The labels are transported here in the form of a tape to the device and segregated into individual labels generally by means of a knife and glued in a conventional manner on objects, preferably on bottles. However, it is also possible to pull tubular films of plastic, so-called sleeves, over the bottles.

Holders of these devices for the tape of labels are known in the form of rolls, the tape being wound on rigid tubes. Particularly, if label tapes of plastic are used, the rigid tube, on which the tape is to be rolled, must already have a certain minimum diameter, in order to assure that the tape can be pulled off without problems. Moreover, because of the smooth surface of the plastic, it is not possible to wind just any amount of tape onto the rigid tube, as otherwise, when the rigid tube is handled, the tape would slip off sideways and telescope. This tendency is present particularly when the tape is in tubular form, because the latter, as a result of the longitudinally extending gluing site or junction, has a somewhat higher edge, so that the layers cannot be wound up straight, but must be wound up at an angle. Finally, narrow tapes can be wound up, if at all, only in a small number of turns on the reel, because the danger of sliding off sideways (telescoping) is too great.

Moreover, it should be noted that the holder of the known device admittedly is provided with a buffer for changing rolls. However, this buffer is dimensioned only for about 40 seconds, in order to connect the end of the running roll with the start of the next roll, after the empty roll has been taken down and the full roll inserted. Since a roll holds only about 30,000 labels and about 600,000 labels can be affixed to the objects during an eight-hour shift, it is necessary to change rolls about every 30 minutes. This is time-consuming and, moreover, requires an operator to be present at all times at this station so that the plant, as a whole, does not come to a stop, if there should be problems with exchanging rolls. Moreover, if the gluing is not carried out properly, the connecting of the end of the running roll to the start of the next roll can lead to breakdowns in the machine, which also once again results in a stoppage, which decreases the productivity of this known device further.

It is an object of the invention to develop a device of the type named above with a greater productivity, so that, basically, it is no longer necessary to exchange rolls.

In the case of a generic device of the introductory portion of the main claim, this objective is accomplished, pursuant to the invention, by the characterizing distinguishing features of the main claim, namely, owing to the fact that the holder is constructed in the form of an exchangeable box, that the box contains the tape of labels in loose zigzag layers one above the other, the top layer of the tape being pulled off for the purpose of dispensing the labels and that the bottom layer of the tape is taken back at least to the height of the top layer and is freely accessible from outside of the box as end piece.

Due to the inventive use of the box with the tape deposited therein, problems such as those encountered in the state of the art, cannot occur since the inventive rolls no longer have to be handled with the danger that the wound-up tape of labels telescopes. A work-intensive exchanging of rolls every 30 minutes is also no longer required here, so that it is possible to make do with one operator less. Finally, gluing sites, which must be produced a total of 16 times per shift, cannot lead to problems during the further processing and, with that, to a stoppage of the device as a whole. Consequently, the productivity of the inventive device is appreciably higher.

In an appropriate embodiment, the individual zigzag layers, which are disposed one above the other, are disposed in random orientation in the plane of the tape, that is, not necessarily precisely above one another. This has the advantage that these boxes can be filled very easily in this manner and also emptied without problems, for the purpose of dispensing. In such a box, which can be used, for example, in a form of a pallet on which the box is placed, a supply of about 300,000 labels of the tape can be provided, which is fully adequate for an 8-hour shift. Moreover, the box can store any number of labels of the tape, irrespective of the smoothness of the surface, of whether the tape consists of flat labels or is in the form of a flexible tube or whether the tape is particularly narrow.

Advantageously, rods, which are disposed one behind the other with respect to the extent of the tape, as well at a distance from the bottom of the box as well as from one another, may be provided, over which the tape, passed back and forth extends and hangs as a V-shaped loop between, in each case, two rods.

Alternatively and pursuant to the invention, compartments, preferably of cardboard, can be disposed one behind the other with respect to the extent of the tape, and the zigzag tape can be passed into the V-shaped compartments sinusoidally in cross section in the form of sagging loops.

Advantageously, the box (5) is used as a unit, which is handled separately and filled with a tape of labels. This enables, for example, medical products to be disinfected separately without any problems.

Further appropriate refinements and developments of the invention are characterized in the dependent claims. An example of the invention is described in greater detail in the following with reference to the drawing, in which

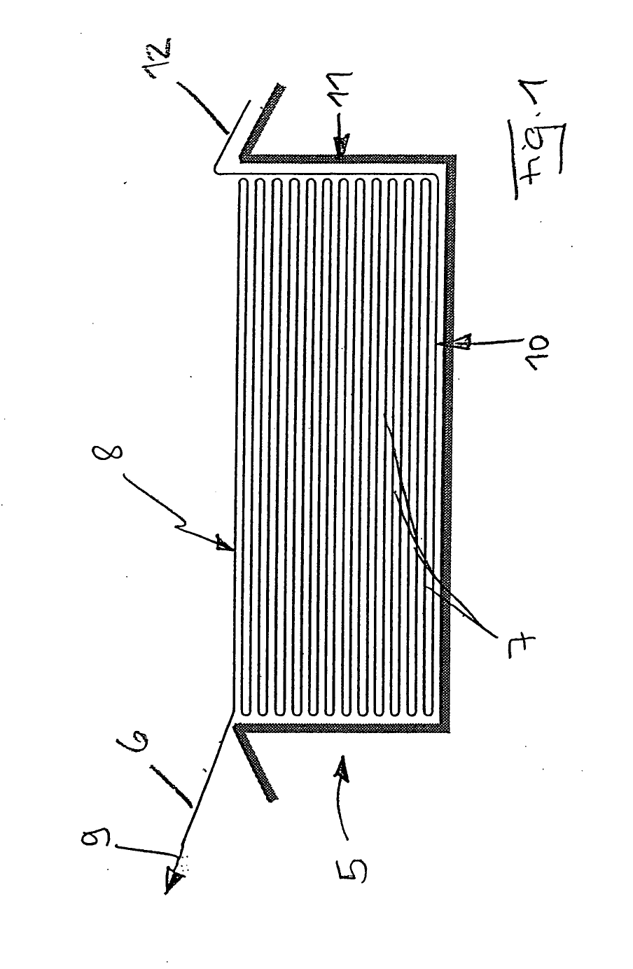

FIG. 1 shows a diagrammatic cross section through a holder of the inventive device,

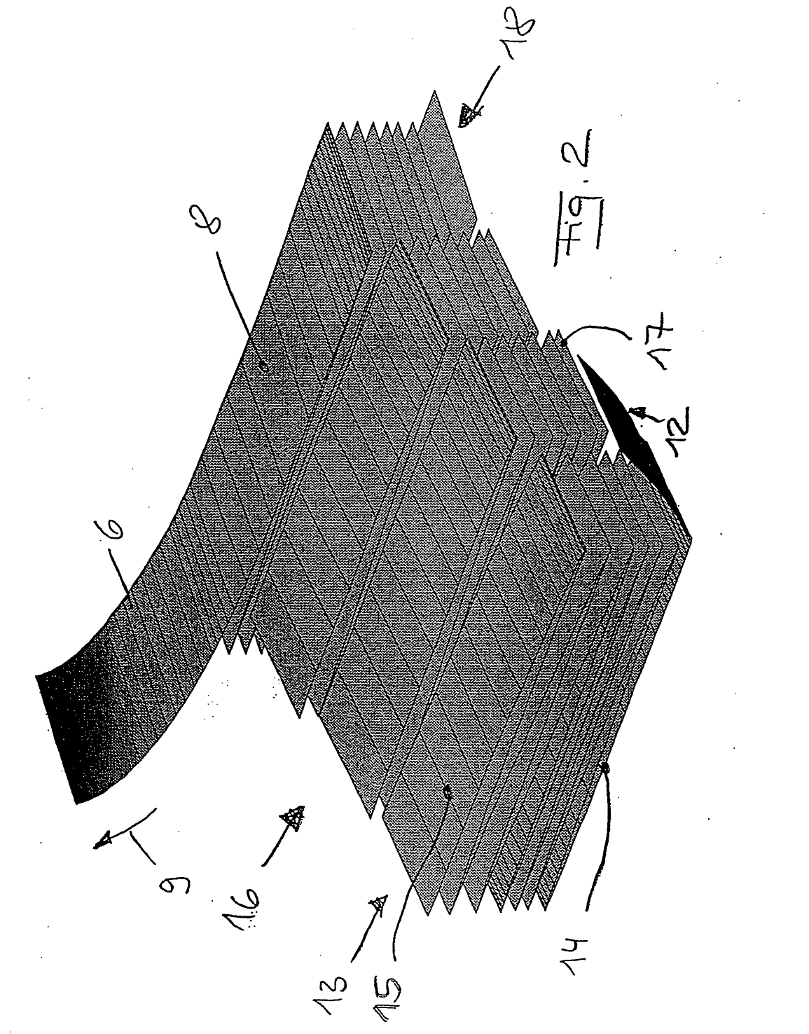

FIG. 2 shows a diagrammatic representation of the tape of labels, which has been deposited in zigzag layers in compartments, which are not shown,

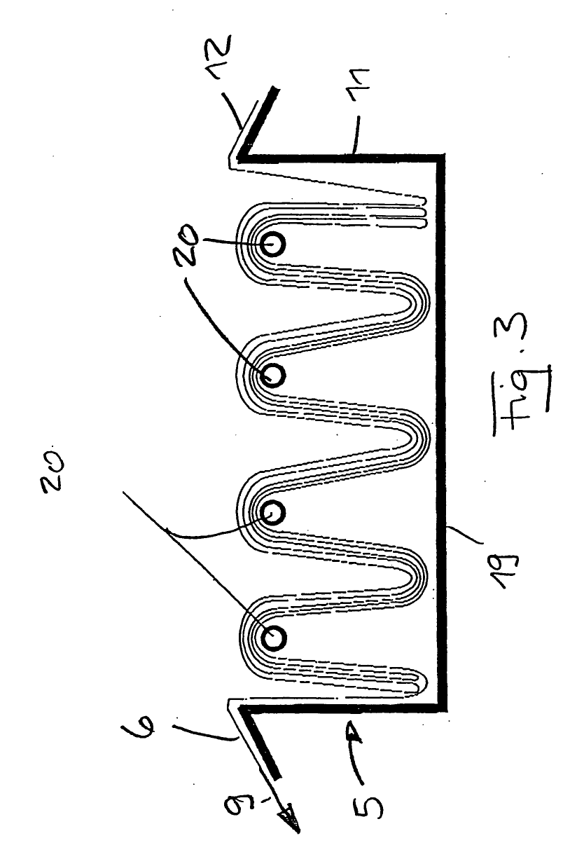

FIG. 3 shows a second embodiment of the invention in a diagrammatic cross section and

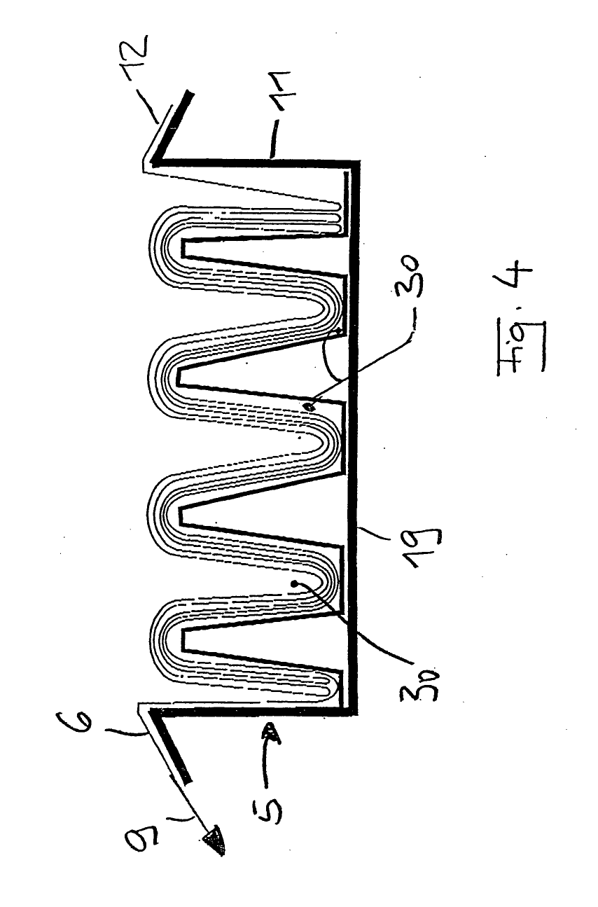

FIG. 4 shows a third embodiment of the invention in a diagrammatic cross section.

FIG. 1 shows a diagrammatic cross section of a box as a holder, which is labeled 5 as a whole and contains the tape 6 of labels in loose zigzag layers 7 one above the other. The top layer 8 of the tape 6 of labels is, as indicated by the directional arrow 9, pulled off for the purpose of dispensing it for labeling in the device which is disposed behind but is not shown.

The bottom layer 10 of the tape 6 is guided at the lateral edge 11 of the box 5 back up to the top layer 8 and is taken from there to the outside of the box 5 as a protruding end piece 12.

For the example of FIG. 2, the layers may be disposed next to one another in individual compartments, which are not shown in FIG. 2. Pursuant to the invention, the lowest layer 14 of the compartment 13, which is filled first, is guided as shown in FIG. 1. The leading-in part of the tape remains as end piece 12. Only the top layer 15 of the first compartment 13 is passed into the second compartment 16, which is disposed next to it and forms the bottom layer 17 there. All other layers of the second compartment 16 are constructed as are the compartments from the first 13 up to the last 18 that have been provided. From there, the top layer 8 is transported further in accordance with the directional arrow 9 for the purpose of dispensing the labels.

FIG. 3 shows essentially the same cross section as FIG. 1. Identical reference numbers refer to identical parts. With regard to the extent of the tape 9, rods 20 are provided one behind the other at a distance from one another and at a distance from the bottom 19 of the box 5. The tape is passed back and forth over the rods 20 in zigzag fashion and sags between the rods 20 in the form a V-shaped loop.

Instead of this, compartments which are V-shaped in cross section can be disposed in a third embodiment (FIG. 4) consecutively in the extent 9 of the tape 6, which is deposited in the form of loops in the compartments in much the same way as in the case of the embodiment of FIG. 3. Here also, identical reference numbers refer to identical parts.

1.-11. (Cancelled)

12. A dispenser containing a plurality of labels for dispensing individual labels for application to objects, each of the labels being in the form of a strip or a sleeve, comprising a holder for the labels in the form of an exchangeable box containing the plurality of labels in the form of a tape arranged in zigzag layers one above the other and including a top layer and a bottom layer, the top layer including a first free end of the tape arranged to be pulled away from the box for the purpose of dispensing the labels, and the tape having a portion contiguous with the bottom layer and including a second free end of the tape, said portion extending upwardly at least to the height of the top layer so that the second free end is accessible from outside of the box.

13. The dispenser of claim 12, wherein the box includes a lateral wall, said upwardly extending portion being adjacent said lateral wall.

14. The dispenser of claim 12 or 13 wherein the second free end protrudes from the box.

15. The dispenser of one of claims 12 to 14, wherein the box is divided into a plurality compartments, the layers are arranged in a plurality of stacks, each in a respective compartment, a first of said stacks includes said second free end and a last of said stacks includes said first fee end, and the tape includes portions connecting the bottom layer of each stack with the top layer of a successive stack.

16. The dispenser of one of claims 12 to 14, wherein the layers are randomly oriented.

17. The dispenser of one of claims 12 to 14, wherein the box comprises a bottom and the dispenser further comprises a plurality of substantially parallel rods substantially equidistantly spaced from each other and having axes in substantially the same plane, said plane being spaced from the bottom of the box, the tape being draped over each of the rods.

18. The dispenser of claim 15, wherein the compartments are arranged in succession in a lengthwise direction of the tape.

19. The dispenser of claim 18, wherein the box comprises a bottom and at least some of the compartments comprise walls oriented transversely of the tape, the walls comprising interior faces of the compartment which converge toward the bottom of the box.

20. The dispenser of claim 19, wherein a folded length of cardboard forms the walls as well as bottoms of the compartments.
